(19) United States
(12) Patent Application Publication
(10) Pub. No.: US 2016/0189404 A1
(43) Pub. Date: Jun. 30, 2016

(54) Selecting and Editing Visual Elements with Attribute Groups

(71) Applicant: MICROSOFT CORPORATION, Redmond, WA (US)

(72) Inventors: Darren K. Edge, Beijing (CN); Koji Yatani, Beijing (CN); Reza Adhitya Saputra, Taipei (CN); Chao Wang, Beijing (CN)

(73) Assignee: Microsoft Corporation, Redmond, WA (US)

(21) Appl. No.: 14/392,248

(22) PCT Filed: Jun. 28, 2013
(86) PCT No.: PCT/CN2013/078288

§ 371 Date: Dec. 24, 2015

(51) Int. Cl. G06T 11/60; G06F 17/21; G06F 17/24

(52) U.S. Cl. CPC G06T 11/60; G06F 17/24; G06F 17/211

(57) ABSTRACT

Techniques for selecting and editing visual elements (e.g., shapes) across multiple visuals (e.g., presentation slides) are described. The techniques obtain the multiple visuals each including visual elements. The visual elements may be grouped and synchronized based on similarities of an attribute among the visual elements. The visual elements may be presented to a user for evaluation. The user may select and make changes to a visual element. These changes may be propagated to other visual elements that belong to the same group of the visual element.

### BACKGROUND

Visual presentations help participants understand presentation content and therefore often make meetings more meaningful and productive. Typically, a user may design and edit a visual presentation after presentation content is chosen. The visual presentation often contains multiple segments, and therefore elements of different segments may not be visible at the same time. Therefore, the user may have a problem to maintain visual consistency across elements of the multiple segments after making changes on some of the elements.

One approach is that the user manually edits all the corresponding elements. In this case, the user must typically navigate through each segment, editing all the elements necessary for maintaining consistency. This approach not only may require considerable work from the user but also is susceptible to errors.

Another approach is to generate templates for the presentation. For example, the user may generate a template containing her desired layouts and text formats in advance. Using the template, the user may then make changes to element layouts and text formats of an individual segment associated with the template. This approach may solve the problem above to a certain degree. However, since generation of templates is primarily an exploratory process, it is often not possible to anticipate desired end results in advance. This dramatically weakens the value of templates.

### SUMMARY

Described herein are techniques for selecting and editing visual elements (e.g., shapes, objects, formats, etc.) within a visual or across multiple visuals (e.g., PowerPoint® slides, Microsoft Word® document pages).

Embodiments of this disclosure obtain the multiple visuals each containing one or more elements. The visual elements may be grouped into multiple groups based on similarities of one or more attributes among the visual elements. The visual elements of a group may be then synchronized by assigning an attribute value to the visual elements. The grouped and synchronized visual elements may be presented to a user for evaluation. In some embodiments, the user may select and make changes to a visual element. These changes may be propagated to other visual elements that belong to the group of the visual element.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1A is a diagram of an illustrative scheme that includes a computing architecture for selecting and editing visual elements using attribute groups.

FIG. 1B is a diagram of an illustrative scheme showing grouping and synchronizing visual elements, and propagating changes among the visual elements.

FIG. 2 is a flow diagram of an illustrative process for grouping, synchronizing, and propagating visual elements using attribute groups.

FIG. 3 is a schematic diagram of an illustrative computing architecture that enables grouping, synchronizing, and propagating visual elements.

FIG. 4 is a flow diagram of an illustrative process for grouping and synchronizing visual elements based on similarities of attribute values among the visual elements.

FIG. 5 is a flow diagram of an illustrative process for modifying attribute groups.

FIG. 6 is a flow diagram of an illustrative process for selecting visual elements and propagating changes to the visual elements.

FIG. 7 is a schematic diagram of an illustrative environment where the a computing device includes network connectivity.

### DETAILED DESCRIPTION

### Overview

Processes and systems described in this disclosure allow users of a computing device to select visual elements (e.g., e.g., shapes, objects, formats, etc.) of a presentation based on similarities of one or more attributes (e.g., shape positions, colors, object types, etc.) among the visual elements using an automated or partially automated process. These visual elements may then be synchronized and/or edited.

The computing device may obtain a visual presentation containing multiple visuals (e.g., slides of a presentation, charts in a report, etc.) each having one or more elements. The computing device may then divide the visual elements into groups based on similarities of the attributes among the visual elements. After grouping, the computing device may synchronize visual elements of a group by assigning an attribute value to the visual elements. The divided and synchronized visual elements may be presented to the users for evaluation. In an example process, the users may select and make changes to a visual element. These changes may be propagated to other visual elements that belong to the group of the visual element.

The processes and systems described herein allow users to create and maintain visual consistency across elements that may not be visible at the same time, and to make changes consistently across visuals in a visual presentation. These processes and systems may be implemented in a number of ways. Example implementations are provided below with reference to the following figures.

### Illustrative Scheme

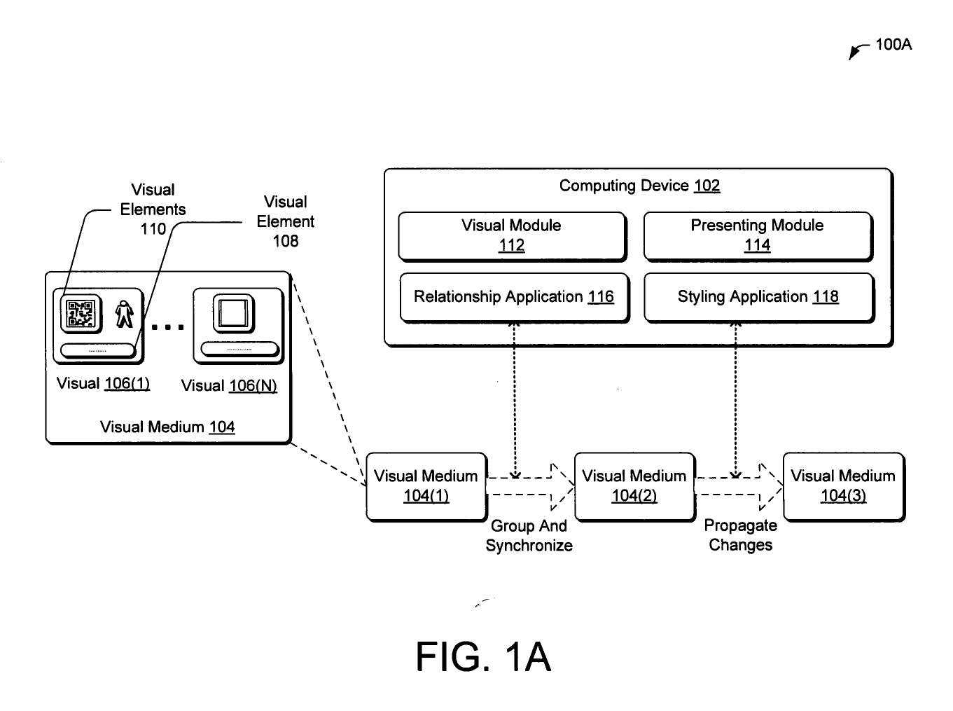

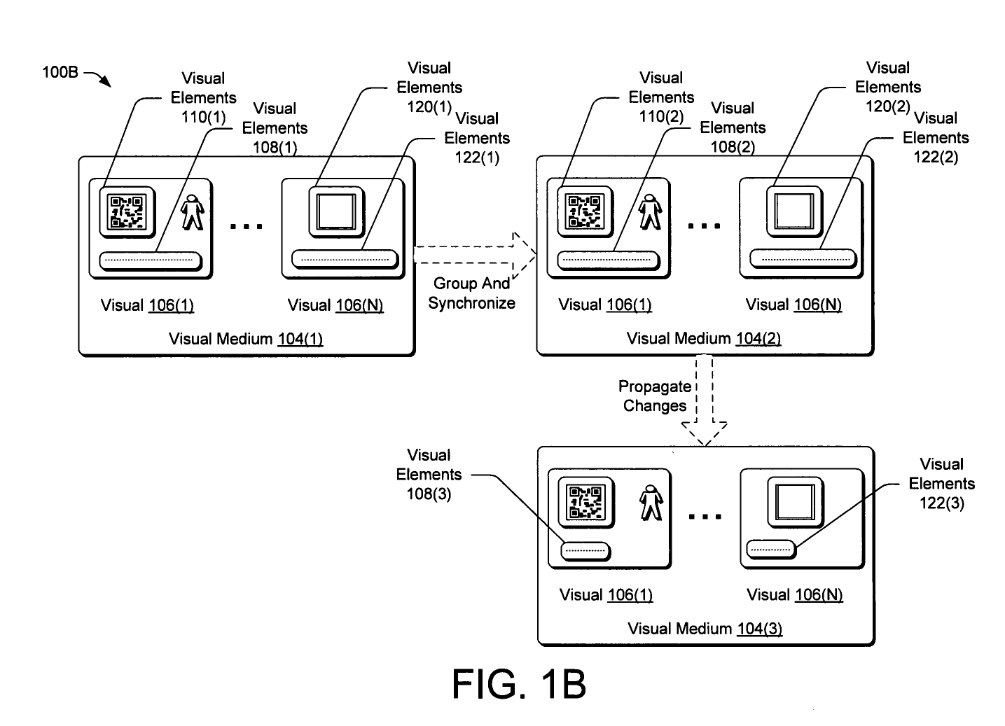

FIG. 1A is a diagram of an illustrative scheme 100A that includes a computing architecture for selecting and editing visual elements using attribute groups. The scheme 100 includes a computing device 102. The computing device 102 may be a desktop computer, a laptop computer, a tablet, a smart phone, or any other types of computing device capable of causing a visual display and change of a visual medium (e.g., a PowerPoint® presentation or Microsoft Word® document). The scheme 100 may be implemented by one or more servers in a non-distributed or a distributed environment (e.g., in a cloud services configuration, etc.)

A visual medium includes one or more visuals (e.g., presentation slides, document pages, etc.). As defined herein, a visual is a space that communicates through a spatial arrangement of visual elements. A visual element is content that has a visual position, bounding box, style or other characteristics that can be categorized as having one or more attributes. In some embodiments, a visual medium 104(1) may include visuals 106(1) . . . 106(N), which further include multiple visual elements (e.g., visual elements 108, and 110) respectively.

Attributes may be properties of visual elements, such as edge positions, text styles, shape styles, and/or other properties. An edge position may include a distance of a visual element's bounding box edging from the respective edge of the visual's bounding box or from a certain origin in a Cartesian coordinate system. For example, in a presentation slide, edge positions are conventionally expressed as “top,” “bottom,” “left,” and “right” attributes. Values of these attributes may be distances from the element to a respective slide edge.

A text style may include a font face, font size, font color, font emphasis (e.g., bold, italic, underline), alignment, or other visual effects (e.g., a glow, shadow, or animation) of a visual element's text content. The alignment may be defined horizontally and/or vertically with respect to bounding box. A shape style may include a bounding box line style (e.g., a width, color, or line type), fill style (e.g., color, fill pattern, or gradient), or other visual effects (e.g., glow, shadow, or animation).

In accordance with various embodiments, the computing device 102, in a basic configuration, may include a visual module 112, a presenting module 114, a relationship application 116, and a styling application 118, each discussed in turn.

The visual module 112 may obtain the visual medium 104, and the presenting module 114 may cause a display of the visual medium. In some embodiments, users may begin by viewing and editing the visual elements. The users may desire to select and coordinate the visual elements within the visual 106(1) or across visuals 106(1) . . . 106(N) based on similarities of one or more attributes among the visual elements.

The relationship application 116 may enable the users to group and synchronize visual elements of visuals to provide greater consistency across a visual presentation. In some embodiments, the relationship application 116 may group and synchronize visual elements with attribute groups. In these instances, an attribute group may include a set of visual elements sharing a particular attribute value or set of attribute values.

In some embodiments, the relationship application 116 may identity multiple visual elements, and may determine one or more attribute values of the multiple visual elements. In some instances, a visual element may have multiple attributes, and therefore the visual element may have multiple attribute values. For example, the visual element 108 may have attribute values associated with a spatial position (e.g., an edge position), a text style (e.g., size), or shape style (e.g., color).

Based on attribute values of the visual elements, the relationship application 116 may divide the multiple visual elements into one or more groups. In some embodiments, the relationship application 116 may group the multiple visual elements into groups based on similarities of one or more attributes among the multiple visual elements. After grouping, the relationship application 116 may synchronize visual elements in a group. In some embodiments, the relationship application 116 may assign an attribute value to visual elements that belong to a group.

After visual elements of a group are synchronized, the user may desire to edit on a visual element of the group and apply the change to the rest of visual elements of the group. In some embodiments, the styling application 118 may enable users to identify the grouped and synchronized visual elements, and to make changes to a visual element. Then, the styling application 118 may propagate the changes to the other visual elements of the group.

In some embodiments, visual elements are grouped and synchronized based on similarities of an attribute among the visual elements, while the same attribute of the visual elements in an attribute group may be styled (i.e., selected and edited) across visuals. For example, the visual elements 108 and 110 are grouped and synchronized based on similarities of the edge positions among the visual elements 108 and 110. Users may change the edge positions of the visual element 108, and the styling application 118 may replicate the change of the edge positions in the visual element 110. In other embodiments, visual elements are grouped and synchronized based on similarities of an attribute among the visual elements, while another attribute of the visual elements may be styled across visuals. For example, the visual elements 108 and 110 are grouped and synchronized based on similarities of the edge positions among the visual elements. Users may change a shape style (e.g., color, size, etc.) of the visual element 108, and the styling application 118 may change the shape style of the visual element 110.

FIG. 1B is a diagram of an illustrative scheme 100B showing grouping and synchronizing visual elements, and propagating changes among the visual elements. In some embodiments, a user may desire to create and/or improve the consistency of the visual medium 104. For example, the visual element 108 and the visual element 110 may have rectilinear bounding boxes, which are located in a similar spatial position of the visuals 106(1) and 106(N) respectively. To improve the consistency of the visual medium 104, the users may desire to select both the visual element 108(1) and the visual element 122(1), and to synchronize these visual elements in the same spatial position of the visuals 106(1) and 106(N) respectively.

In some embodiments, the relationship application 116 may group visual elements across visuals based on similarities of one or more attribute among the visual elements. For example, based on similarities of a spatial position (e.g., one or more edge positions) among the visual elements 108(1), 110(1), 120(1), and 122(1), the relationship application 116 may group these visual elements into multiple groups, such as a group for the visual elements 108(1) and 122(1) and another group for the visual elements 110(1) and 122(1).

Further, the relationship application 116 may synchronize the grouped visual elements. In these instances, the relationship application 116 may assign one or more attribute values to the grouped visual elements. For example, the relationship application 116 may assign an optimal value of the spatial position to the visual elements 108(1) and 122(1), and another optimal value to the visual elements 110(1) and 122(1). The optimal value may be predetermined or calculated by the relationship application 116. In response to users' approval, the relationship application 116 may apply changes of spatial positions to the visual elements 108(1), 110(1), 120(1), and 122(1). For example, a resulting visual medium 104(2) shows grouped and synchronized visual elements 108(2), 110(2), 120(2), and 122(2). For example, after grouping and synchronizing, the visual elements 110(2) and visual element 120(2) as well as the visual elements 108(2) and visual element 122(2) are aligned together respectively.

In some embodiments, the user may desire to edit on a visual element of the group and apply the change to the rest of visual elements of the group. The styling application 118 may identify the grouped visual elements, and determine the change that the user makes on a visual element. Then, the styling application 118 may propagate the change to the other visual elements of the group.

For example, suppose that the visual elements 108(2) and 122(2) are grouped within a group by the relationship application 116. In response to a determination that the user selects the visual element 108(2), the styling application 118 may identify the group that the visual element 108(2) belongs to, and that the visual element 122(2) is associated with the group. Further, in response to a determination that the user changes the length of the visual element 108(2), the styling application 118 may change the length of the visual element 122(2). For example, a resulting visual medium 104(3) shows that the length change of visual elements 108(3) is replicated to 122(3).

### Illustrative Operation

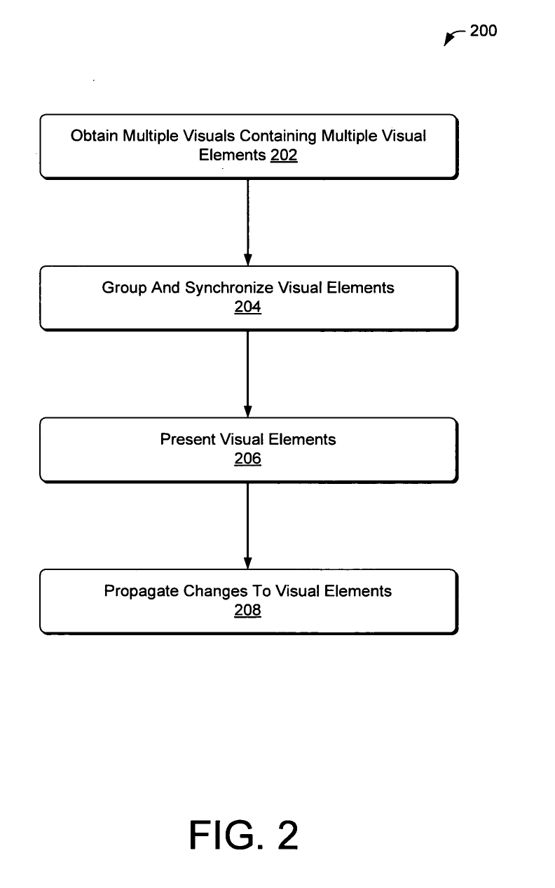

FIG. 2 is a flow diagram of an illustrative process for grouping and editing visual elements using attribute groups. The process 200 is illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 200, shall be interpreted accordingly. The process 200 is described with reference to the scheme 100. However, the process 200 may be implemented using other schemes, environments, and/or computing architecture.

At 202, the visual module 112 may obtain a visual medium containing multiple visuals. Individual visuals may include multiple visual elements. The presenting module 114 may cause a display of the visual medium. The visual medium may be displayed within a window including an overview sub-window showing multiple visuals and a detailed sub-window showing one or more visuals in a higher resolution. In some embodiments, visual elements of a visual may be highlighted in the detailed sub-window.

At 204, the relationship application 116 may group and synchronize the multiple visual elements with attribute groups. In some embodiments, the relationship application 116 may group the multiple visual elements based on one or more attributes (e.g., a spatial positions, text style, and/or shape style) associated with the multiple visual elements. In these instances, the relationship application 116 may group the multiple visual elements into multiple groups based on similarities of the one or more attributes among the multiple visual elements. Accordingly, attribute values of visual elements that belong to a group are similar with respect to visual elements of other groups. In some embodiments, the relationship application 116 may synchronize the visual elements of a group by assigning an optimal attribute value to the visual elements and therefore generating an attribute group.

At 206, the presenting module 114 may present the grouped and synchronized visual elements by causing a display of the visual medium. In some embodiments, in response to a user's selection of a visual element, the styling application 118 may identify the attribute group of the visual element and other visual elements that belong to the attribute group. In some embodiments, the user may select an attribute to view visual elements sharing a same attribute value with respect to the attribute. In these instances, the styling application 118 may identify visual elements that belong to a group or an attribute group corresponding to the attribute. In addition, the presenting module 114 may highlight these identified visual elements to enable the user to evaluate the group and synchronize results and/or to perform further modifications and/or changes, which is discussed in great detail below.

At 208, the styling application 118 may propagate changes on a visual element to the identified visual elements in response to a determination that the user makes changes to a visual element of the identified visual elements, which is discussed in great detail below. In some embodiments, changes resulting from one or more processes of grouping, synchronizing, and propagating may be applied or discarded, and the user may return to a regular editing mode.

### Illustrative Computing Architecture

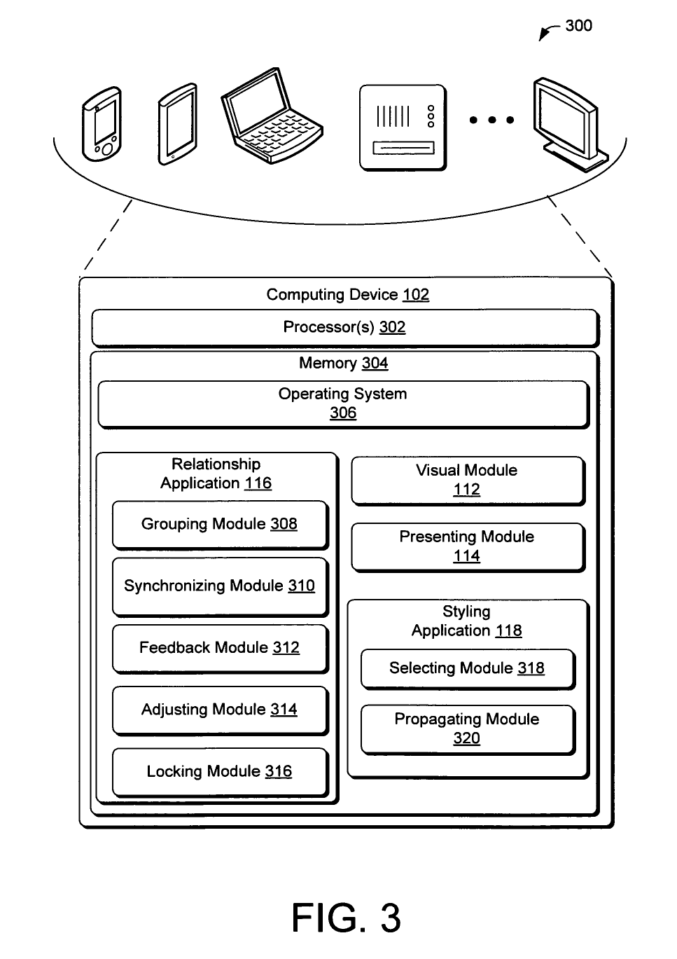

FIG. 3 is a schematic diagram of an illustrative computing architecture 300 to enable creation and animation of avatars using body gestures. The computing architecture 300 shows additional details of the computing device 102, which may include additional modules, data, and/or hardware.

The computing architecture 300 may include processor(s) 302 and memory 304. The memory 304 may store various modules, applications, programs, or other data. The memory 304 may include instructions that, when executed by the processor(s) 302, cause the processor(s) to perform the operations described herein for the computing device 102.

The computing device 102 may have additional features and/or functionality. For example, the computing device 102 may also include additional data storage devices (removable and/or non-removable) such as, for example, magnetic disks, optical disks, or tape. Such additional storage may include removable storage and/or non-removable storage. Computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, program data, or other data. The system memory, the removable storage and the non-removable storage are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other medium that can be used to store the desired information and which can be accessed by the computing device 102. Any such computer storage media may be part of the computing device 102. Moreover, the computer-readable media may include computer-executable instructions that, when executed by the processor(s), perform various functions and/or operations described herein.

In contrast, communication media may embody computer-readable instructions, data structures, program modules, or other data in a modulated data signal, such as a carrier wave, or other mechanism. As defined herein, computer storage media does not include communication media.

The memory 304 may store an operating system 306 as well as the visual module 112, the presenting module 114, the relationship application 116, and the styling application 118.

The relationship application 116 may include various modules such as a grouping module 308, a synchronizing module 310, a feedback module 312, an adjusting module 314, and a locking module 316. Each of these modules is discussed in turn.

The grouping module 308 may group the visual elements 108(1), 110(1), 120(1), and 122(1) into one or more groups based on similarities of one or more attributes (e.g., a spatial position, text style, and/or shape style) among these visual elements. The grouping may include dividing, clustering, coordinating, or otherwise processing the visual elements to detect, classify, organize, and/or associate similarities of the attributes. In some embodiments, the grouping module 308 may select an attribute to group based on a predetermined rule or a type or nature of the visual medium 104. For example, for a visual presentation (e.g., PowerPoint® slides), the grouping module 308 may select a spatial position (e.g., edge positions), and group the visual elements 108(1), 110(1), 120(1), and 122(1) into two groups or sets: one group for the visual elements 108(1) and 122(1), and another group for the visual elements 110(1) and 120(1). For example, for a word processed document, the grouping module 308 may select a textual attribute (e.g., a line spacing, line justification, font face, size, or color) to group visual elements of the document. However, it is to be appreciate that grouping using spatial attributes may also be applied to word processed documents (e.g., image locations), and grouping textual attributes may also be applied to a visual presentations (e.g., font faces).

In some embodiments, a user may select or specify an attribute for grouping. In these instances, the grouping module 308 may group the visual elements 108(1), 110(1), 120(1), and 122(1) based on similarities of the attribute among the visual elements. For example, the grouping module 308 may detect that the user, through a user interface, selected the left edge position as the attribute. In response to the detection, the grouping module 308 may group the visual elements 108(1), 110(1), 120(1), and 122(1) based on similarities of the left edge positions of the visual elements. As a result, the visual elements 108(1), 110(1), 120(1), and 122(1) may be grouped into two groups: one group for the visual element 108(1), 110(1), and 122(1), and another group for the visual element 120(1). In some embodiments, the grouping module 308 may group the visual elements using a clustering algorithm (e.g., a hierarchical clustering or Centroid-based clustering).

In some instances, a hierarchical clustering algorithm may be used to group the visual elements 108(1), 110(1), 120(1), and 122(1). Attribute values of the visual elements may be represented on a linear scale (e.g. edge, positions, font sizes, or color hues).

In some embodiments, the clustering process may begin with each attribute value in a cluster of the attribute value. The clustering process may then combine the two closest clusters on iteration, and represent the cluster with a derived value. This derived value may be a measure of central tendency (e.g., a mode, median, or mean value), extremity (e.g., min or max), or some other measure. The modal value may be selected from existing values for final output and operate by majority voting, which may be preferable to the mean in situations where initial inputs have specific desirable properties (e.g., color hues) that cannot be satisfactorily replaced by averages. When multi-valued clusters are compared, the number of attributes represented by each cluster may be used to determine which cluster represents the modal value. In the event of a tie, the most desirable cluster can be selected based on some other criteria, for example, to make the visual elements of slides occupy more of the available space by prioritizing extreme values (e.g., the leftmost left edge, topmost top edge, etc.).

For example, if the initial values were 1, 1, 2, 4, 7, 7, 8, 9, the clustering procedure may select minimum values in the event of a tie and then use a notation (i.e., cluster value: clustered values), as illustrated in table 1.

TABLE 1

| | | | | | | | | |
|---|---|---|---|---|---|---|---|---|
| 8 clusters | (1:1) | (1:1) | (2:2) | (4:4) | (7:7) | (7:7) | (8:8) | (9:9) |
| 7 clusters | (1:1, 1) | (2:2) | (4:4) | (7:7), | (7:7) | (8:8) | (9:9) | |
| 6 clusters | (1:1, 1) | (2:2) | (4:4) | (7:7, 7) | (8:8) | (9:9) | | |
| 5 clusters | (1:1, 1, 2) | (4:4) | (7:7, 7) | (8:8) | (9:9) | | | |
| 4 clusters | (1:1, 1, 2) | (4:4) | (7:7, 7, 8) | (9:9) | | | | |
| 3 clusters | (1:1, 1, 2) | (4:4) | (7:7, 7, 8, 9) | | | | | |
| 2 clusters | (1:1, 1, 2, 4) | (7:7, 7, 8, 9) | | | | | | |
| 1 cluster | (1:1, 1, 2, 4, 7, 7, 8, 9) | | | | | | | |

In some embodiments, an error function may be used to calculate which these levels of clustering are “optimal” (i.e., maximizes similarity within clusters and distance between clusters). For example, the function may be defined using equations (Eq) (1)-(5) below.

$$\begin{matrix}Error = α \times Intercluster Error + ( 1 - α ) \times Intracluster Error & Eq ( 1 ) \\ α = Strength of grouping [ 0 , 1 ] & Eq ( 2 ) \\ {Centroid}_{i} = ( {\sum }_{j = 1 \\ j ∈ i}^{N} j ) \text{/} N & Eq ( 3 ) \\ Intercluster Error = {\sum }_{i = 1 \\ i ∈ Clusters}^{N} ( {Centroid}_{i} - {Centroid}_{global} ) & Eq ( 4 ) \\ Intracluster Error = {\sum }_{i = 1 \\ i ∈ Clusters}^{M} {\sum }_{j = 1 \\ j ∈ {Elements}_{i}}^{N} ( {Centroid}_{i} - {Element}_{j} ) & Eq ( 5 )\end{matrix}$$

For example, the error function may pick out the level of 3 clusters as optimal and group all 8 attributes to the values of 1, 4, and 7 respectively. In some embodiments, the hierarchical clustering may be performed for an individual attribute of attributes that are selected or specified by the user (e.g., the four edge positions).

After the visual elements are grouped into one or more groups, the synchronizing module 310 may synchronize the visual elements of a group by assigning an attribute value to generate an attribute group. Therefore, visual elements of an attribute group share an attribute value with respect to the attribute selected or specified for the grouping.

In some embodiments, what is optimal at the attribute level may be suboptimal at the element level. For example, visual elements may be distorted out of shape, or brought to overlap in undesirable ways after being grouped and synchronized.

In some embodiments, the feedback module 312 may detect or determine problematic results after visual elements are grouped and synchronized. For example, problems may include edge position overlapping such that a visual element's active region (e.g., containing visible elements such as text, images, or background fill) overlaps with other visual elements while the overlapping did not exist before grouping and synchronizing. The feedback module may detect the problematic results, and then provide feedback to the user. In some instances, the feedback module 312 may enable the user to change a parameter associated with grouping (e.g., a grouping strength of equation (2)) and therefore to remove or add visual elements into a certain group. In some instances, the adjusting module 314 may enable the user to manually remove unwanted elements from a group or add additional elements to the group.

In some embodiments, the presenting module 114 may cause a display of the grouped and synchronized visual elements and feedback. In some instances, the feedback may be displayed around each visual element indicating an extent to which attribute values have changed as a result of the grouping and synchronizing. For example, colors of bounding box edges may indicate the extent to which they have moved, either in absolute or relative terms. Accordingly, the user may then evaluate the grouping and synchronizing results.

In some embodiments, the user may re-group with a different grouping parameter (e.g., a grouping strength) if the user is not satisfied with a grouping and/or synchronizing result. For example, a result after automatically grouping and/or synchronizing may be over or under aggressive. A sign of under grouping and/or synchronizing may be indicated by attributes that should be grouped and synchronized but haven't. A sign of over grouping and/or synchronizing may be indicated by elements that have been deformed or moved with respect to one another in undesirable ways.

In some embodiments, the locking module 316 may enable the user to manually grouping those elements within a visual that should not move with respect to one another (e.g., diagram elements) before automatic grouping and/or synchronizing. In some instances, the locking module 316 may enable a user to manually lock elements to be ignored by the grouping process. In some instances, the locking module 316 may associate a visual element with another visual element such that these visual elements remain in position and attract other non-locked elements. For example, the edge position values of these visual elements may be automatically set for a certain group.

In some embodiments, changes resulting from the grouping and synchronizing process may be either applied or discarded in response to the user's instructions. In some instances, the relationship application 116, via bounding boxes, may group a certain visual element into another group in response to a determination that the user manually drags the edges of the certain visual element. In some instances, changes occurring in a visual may be reverted while preserving effects on remaining visuals.

In some embodiments, another solution may be used to resolve problematic results as discussed above. In some instances, the adjusting module 314 may fix visual elements locally (e.g., within a visual) during the grouping process. For example, the adjusting module 314 may reposition one edge of visual elements in response to a determination that the visual elements are deformed beyond an acceptable deviation. The acceptable deviation may include a predetermined value in terms of an aspect ratio (e.g., 5% for an image, 50% for a text box). In some instances, peripheral edges may be preserved (e.g., those that tend to form whitespace margins around slide content), while inner edges are allowed to vary. In some instances, the adjusting module may shrink visual elements in response to a determination that one visual element overlaps with another after grouping and synchronizing. In other instances, the adjusting module may shrink visual elements in response to a user's instructions (e.g., a shrinking parameter) and/or a selection of the visual elements.

The styling application 118 may include various modules such as a selecting module 318 and a propagating module 320. Each of these modules is discussed in turn.

In some embodiments, the selecting module 318 may enable a user to select visual elements based on similarities of one or more attributes of the visual elements. For example, the user may select visual elements and desire to identify and to select other visual elements sharing similar attributes with the visual element. In some embodiments, in response to the determination of the user's selection, the selecting module 318 may identify visual elements sharing similar attributes with the visual element. In some instances, the selecting module 318 may identify a group including the visual element with respect to one or more attributes, and then the rest of visual elements in the group. In some instances, the selecting module 318 may identify the attribute group of the visual element with respect to a certain attribute, and identify the other visual elements in the attribute group.

In some embodiments, the selecting module 318 may identify visual elements in response to an attribute specified by the user. In these instances, the visual elements sharing a same or similar attribute value of the specified attribute may be identified and selected. For example, visual elements may be identified and selected based on a spatial position attribute. Accordingly, visual elements that share the same position (e.g., one or more of four edge position attributes) may be identified and selected (e.g., highlighted). For example, visual elements may be identified and selected based on attributes associated with a text style. Accordingly, visual elements that share the same text style (e.g., font face, emphasis, size, color, or alignment) may be identified and selected.

In some embodiments, the presenting module 114 may provide immediate visual feedback about which visual elements are selected by the selecting module 318. In these instances, the presenting module 114 may cause a display of selected visual elements and/or unselected visual elements. In some instances, the presenting module 114 may highlight the selected visual elements while de-emphasizing the unselected visual elements. Accordingly, the user may manually add additional elements to this group, remove unwanted elements from it, or change the attributes affecting the grouping.

The propagating module 320 may propagate changes on a visual element to the rest of the visual element that are selected by the selecting module 318. In some instances, the user may be allowed to resize or reposition the visual element to propagate to the whole attribute group that the visual belongs to. In some instances, the user may be allowed to restyle text attributes of the visual elements to propagate to the whole group. Accordingly, as any attribute of any selected element is edited, the style changes may be visually propagated to all grouped elements. These changes can be applied or discarded before returning to the regular editing mode.

In some embodiments, automatic grouping and synchronizing may be performed on manually added visual elements with respect to an attribute associated with the added visual elements. In some embodiments, the user may also specify attributes to select and to synchronize across grouped visual elements. In some instances, visual elements may be grouped by an attribute or one set of attributes (e.g., edge positions) while synchronizing another (e.g., their text styles). In these instances, the styling application 118 may update the attribute of the manually added visual elements to have the same attribute value.

### Illustrative Operations

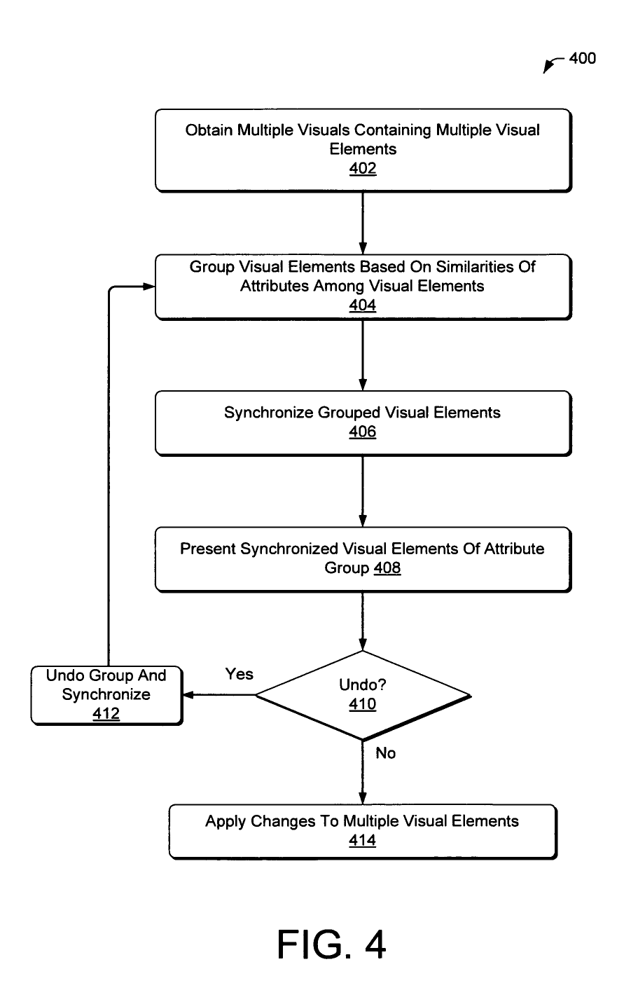

FIG. 4 is a flow diagram of an illustrative process 400 grouping and editing visual elements based on similarities of attribute values among the visual elements. At 402, the visual module 112 may obtain a visual medium containing multiple visuals. An individual visual of the multiple visuals may include one or more visual elements. For example, the visual 106(N) includes the visual elements 120(1) and 122(1).

At 404, the grouping module 308 may group visual elements of the multiple visuals into one or more groups based on similarities of one or more attributes among the visual elements. In some embodiments, the grouping may be implemented on each attribute of the one or more attributes attribute using a clustering algorithm. For example, the grouping module 308 may build hierarchical clusters for each attribute among the visual elements. In some embodiments, a user may select certain visuals for grouping. In these instances, the grouping module 308 may group the visual elements of the selected visuals. In some embodiments, a user may select certain visual elements from the multiple visuals for grouping. In these instances, the grouping module 308 may group the selected visual elements. In some embodiments, the user may select or specify an attribute for grouping. In these instances, the grouping module 308 may group visual elements based on similarities of the selected attribute among the visual elements.

At 406, the synchronizing module 310 may synchronize visual elements of a group by assigning an attribute value to the visual elements and therefore generating an attribute group. In some embodiments, the attribute value may be determined by selecting existing attribute values of the group for final output based on majority voting such that initial inputs have specific desirable properties. These properties, such as color hues, may not be satisfactorily replaced by averages.

At 408, the presenting module 114 may cause a display of the grouped and synchronized visual elements. In some embodiments, the visual elements may be displayed within a visual or across the multiple visuals. In some instances, different groups may be differentiated by the color of highlight borders drawn around the elements of each group.

At 410, the relationship application 116 may determine whether to undo a grouping and synchronizing. For example, the user does not like automatic grouping and synchronizing results, and desires to re-group based on similarities of a different attribute or using a different grouping strength. Thus, the decision operation 410 may enable the user to discard changes to attributes associated with the visual elements. When the decision operation 410 determines to undo (i.e., the “yes” branch of the decision operation 410), the process 400 may advance to an operation 412.

At 412, the relationship application 116 may remove any changes to the attributes associated with the visual elements. Accordingly, the attribute values of these visual elements are reverted to those prior to implementation of the operation 404. Following the operation 412, the process may return to the operation 404 to allow another grouping and synchronizing process. For example, the relationship application 116 may group and synchronize the visual elements using a different grouping parameter or based on similarities of a different attribute among the visual elements.

When the decision operation 410 determines not to undo the grouping and synchronizing, the process 400 may advance to an operation 414. At 414, the relationship application 116 may apply changes to the attributes associated with the visual elements.

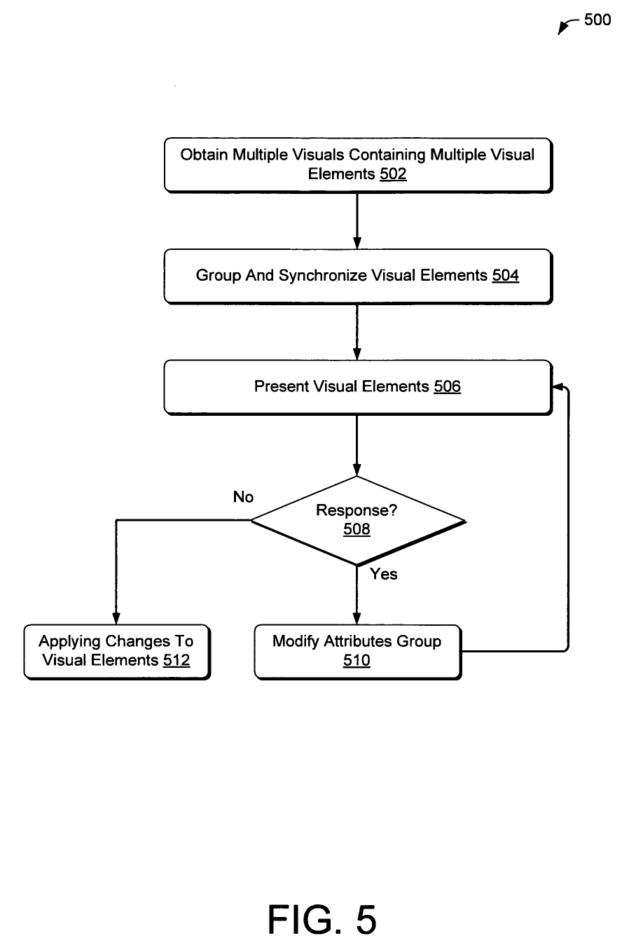

FIG. 5 is a flow diagram of an illustrative process 500 for modifying attribute groups. At 502, the visual module 112 may obtain multiple visuals each including multiple visual elements. At 504, the relationship application 116 may group the visual elements into one or more attribute groups based on similarities of an attribute among the visual elements.

At 506, the presenting module 114 may cause a display of the grouped and synchronized visual elements. In some embodiments, the presenting module 114 may show feedback about element groups. For example, feedback may be displayed around each visual element indicating the extent to which the attribute values have changed as a result of the grouping and synchronizing. In some embodiments, element groups may have two states: grouped and synchronized and unselected. The presenting module 114 may cause a display of the grouped and synchronized or unselected element groups in response to a selection of the user. In these instances, different groups may be differentiated by the color of highlight borders drawn around the elements of each group. Accordingly, a group may be identified by the visual elements that would be in the same place in response to the optimal grouping and synchronizing.

At 508, the relationship application 116 may determine whether a user response is received. For example, the user may not like automatic grouping and synchronizing results, and desire to modify a certain attribute group. When the relationship application 116 determines the response (i.e., the “yes” branch of the decision operation 508), the process 500 may advance to 510.

At 510, the adjusting module 314 may modify the attribute group based on the response of the user. For example, the adjusting module 314 may enable the user to manually add additional elements to a certain attribute group, remove unwanted elements from the attribute group, or change the attributes affecting the grouping and synchronizing. Following the operation 510, the process 500 may advance to 506 to allow anther evaluation process. In some embodiments, element groups may then be grouped and synchronized together or independently using toggling, with the result updating dynamically on the underlying visuals elements in a group moving from the initial attribute values (e.g., text styles) to newly shared attribute values (e.g., edge positions).

When the relationship application 116 does not determine that the response is not received (i.e., the “no” branch of the decision operation 508), the process 500 may advance to the operation 512. The relationship application 116 may apply changes to visual elements associated with corresponding attribute groups.

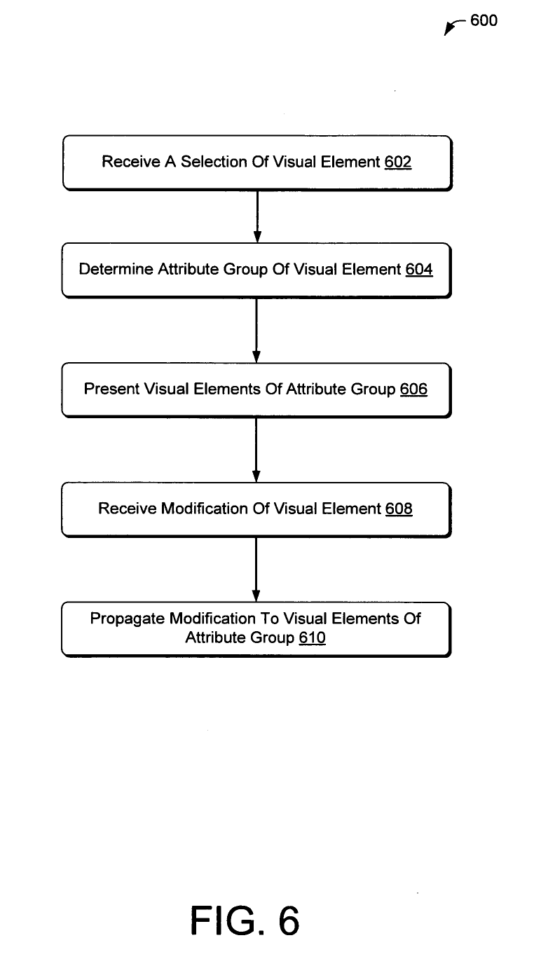

FIG. 6 is a flow diagram of an illustrative process for selecting visual elements and propagating changes to the visual elements. At 602, the selecting module 318 may detect that a user selects a visual element of a visual medium. The visual medium may contain multiple visuals. In some embodiments, the visual elements have been grouped and synchronized into multiple attribute groups. In some embodiments, the user may select the visual element via an interface by moving a cursor to the visual element. In some embodiments, the selecting module 318 may also enable the user to select visual elements by specifying an attribute. For example, visual elements may be selected based on one or more attributes associated with a spatial position or a text style.

At 604, the selecting module 318 may identify or determine the attribute group that the selected visual element belongs to. In some embodiments, a visual element may belong to multiple attribute groups. In these instances, the selecting module 318 may choose an attribute group associated with a certain attribute based on a predetermined condition. In other instances, the styling application 118 may detect a selection of an attribute specified by a user, and the selecting module 318 may determine the attribute group based on the specified attribute.

At 606, the presenting module 114 may identify and present visual elements of the attribute group. In some embodiments, the presenting module 114 may cause a display by highlighting the selected (i.e., identified) visual elements while de-emphasizing the unselected visual elements. In some embodiments, the styling application 118 may enable the user to add additional visual elements to the attribute group, remove unwanted elements from the attribute group, or change the attributes affecting the grouping to generate an updated attribute group.

At 608, the styling application 118 may receive a modification of a visual element. For example, the user may change a size, position, shape style, or text style of the visual element.

At 610, the propagating module 322 may propagate the modification to the visual elements of the attribute group.

### Illustrative Environment

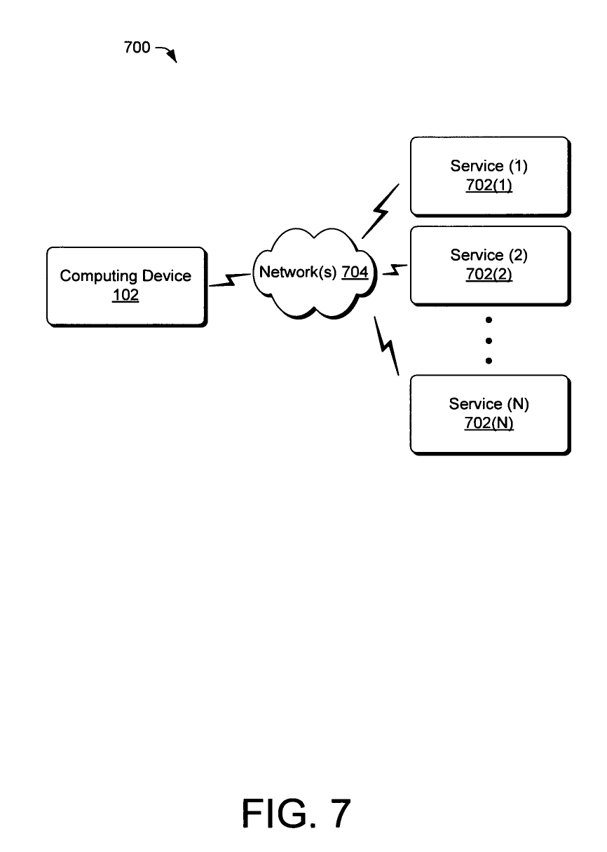

FIG. 7 is a schematic diagram of an illustrative environment 700 where the computing device 102 includes network connectivity. The environment 700 may include communication between the computing device 102 and one or more services, such as services 702(1), 702(2) . . . 702(N) through one or more networks 704. The networks may include wired or wireless networks, such as Wi-Fi networks, mobile telephone networks, and so forth.

The services 702(1)-(N) may host a portion of or the all functions shown in the computing architecture 300. For example, the services 702(1)-(N) may store the program data for access in other computing environments, may perform the grouping and synchronizing processes or portions thereof, may perform the styling processes or portions thereof, and so forth. The services 702(1)-(N) may be representative of a distributed computing environment, such as a cloud services computing environment.

### CONCLUSION

Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. One or more computer-readable media storing computer-executable instructions that, when executed by one or more processors, instruct the one or more processors to perform acts comprising:
obtaining a visual medium containing multiple visuals;
grouping multiple visual elements of the multiple visuals into a plurality of groups based on similarities of one or more attributes among the multiple visual elements;
synchronizing visual elements of a group of the plurality of groups; and
propagating modification to the visual elements of the group in response to a determination of the modification of a visual element of the group.

2. The one or more computer-readable media of claim 1, wherein a plurality of visual elements of the group share at least one attribute value.

3. The one or more computer-readable media of claim 1, wherein the one or more attributes include at least one of a spatial position, a text style, or a shape style associated with the multiple visual elements.

4. The one or more computer-readable media of claim 1, wherein the one or more attributes include an edge position.

5. A computer-implemented method for grouping visual elements, the method comprising:
obtaining, by a computer device, a visual presentation containing multiple visuals;
grouping multiple visual elements of the multiple visuals to generate multiple groups based on similarities of one or more attributes among multiple visual elements;
presenting visual elements of a group of the multiple groups across the multiple visuals; and
propagating changes to visual elements of the group in response to a determination of the changes on a visual element of the group.

6. The computer-implemented method of claim 5, wherein the one or more attributes include at least one of an edge position, a text style, or a shape style associated with the multiple visual elements.

7. The computer-implemented method of claim 5, further comprising:
adjusting the group by adding or removing a certain visual element in response to user feedback.

8. A system for editing visual elements, the system comprising:
one or more processors; and
memory to maintain a plurality of components executable by the one or more processors, the plurality of components comprising:
a grouping module executable by the one or more processors and configured to group multiple visual elements of multiple visuals to generate multiple groups based on similarities of one or more attributes among multiple visual elements,
a selecting module executable by the one or more processors and configured to receive a selection of a certain visual element and a modification of the certain visual element, and
a propagating module executable by the one or more processors and configured to:
determine a group corresponding to the certain visual element, and
propagate the modification to visual elements of the group.

9. The system of claim 8, wherein the one or more attributes include edge positions associated with the multiple visual elements.

10. The system of claim 8, further comprising a presentation module executable by the one or more processors and configured to highlight differences between the visual elements and the propagated visual elements across the multiple visuals.
